(19) United States
(12) Patent Application Publication
(10) Pub. No.: US 2026/0311922 A1
(43) Pub. Date: Oct. 8, 2026

(54) OPTICAL ELEMENT DRIVING MECHANISM

(71) Applicant: Actutek Corporation, Taoyuan City (TW)

(72) Inventors: Ya-Hsiu WU, Taoyuan City (TW); Yi-Ho CHEN, Taoyuan City (TW); Ying-Jen WANG, Taoyuan City (TW); Sin-Jhong SONG, Taoyuan City (TW); Chia-Che WU, Taoyuan City (TW)

(21) Appl. No.: 19/634,856

(22) Filed: Mar. 31, 2026

Related U.S. Application Data
(60) Provisional application No. 63/782,234, filed on Apr. 2, 2025.

(51) Int. Cl. H01F 7/08; G02B 7/00; H01F 7/06

(52) U.S. Cl. CPC H01F 7/081; G02B 7/00; H01F 7/064

(57) ABSTRACT

An optical element driving mechanism is provided, the optical element driving mechanism includes a first movable portion, a fixed portion, and a first driving component. The first movable portion is configured to connect the optical element having an optical axis. The first movable portion is movable relative to the fixed portion. The first driving component is configured to drive the first movable portion to move relative to the fixed portion.

### CROSS REFERENCE TO RELATED APPLICATIONS

This application claims the benefit of U.S. provisional application No. 63/782,234, filed Apr. 2, 2025, the entirety of which is incorporated by reference herein.

### TECHNICAL FIELD

This invention relates to an optical element driving mechanism, and in particular it relates to an optical element driving mechanism having a connecting component.

### BACKGROUND

As smart electronic devices continue to evolve toward thinner form factors and higher levels of integration, enabling stable and precise motion control of optical systems within limited space has become an important focus in the relevant technical field. Conventional optical element driving mechanisms typically include a movable portion and a fixed portion, and a driving component disposed between the movable portion and the fixed portion, such that the movable portion may drive an optical element to move relative to the fixed portion. In this way, functions such as auto-focusing, optical image stabilization, and image compensation can be achieved.

However, in conventional designs, the driving component is often disposed on a single movable portion. As such, movement in multiple directions typically requires multiple structural elements to move together, and this may increase the moving load and reduce actuation efficiency. In addition, in certain single-layer optical element driving mechanisms, if the movable portion lacks appropriate guiding or constraining structures during movement, it may not be possible to effectively control its direction of motion. This may result in unintended rotation or deviation and thereby affect the stability of the overall motion. Accordingly, how to reduce the moving load while maintaining structural configuration and degrees of freedom and improving the motion stability of the movable portion remains a challenge in the art.

### BRIEF SUMMARY

This invention provides an optical element driving mechanism, which includes a first movable portion, a fixed portion, and a first driving component. The first movable portion is configured to connect an optical element having an optical axis. The first movable portion is movable relative to the fixed portion. The first driving component is configured to drive the first movable portion to move relative to the fixed portion.

In some embodiments of the present disclosure, the optical element driving mechanism further includes a first connecting component. The first movable portion is movable relative to the fixed portion via the first connecting component. The first connecting component includes a first connecting element located between the first movable portion and the fixed portion. The first connecting element is movable relative to the fixed portion, and the first connecting element is movable relative to the first movable portion.

### BRIEF DESCRIPTION OF THE DRAWINGS

The embodiments of this disclosure is described in detail below with reference to the accompanying drawings. It should be noted that, in accordance with industry standard practice, many features are not drawn to scale and are only used for illustrative purposes. In fact, the dimensions of the components may be arbitrarily enlarged or reduced to clearly demonstrate the features of this disclosure.

FIG. 1 shows a perspective view of an optical element driving mechanism according to some embodiments of the present disclosure.

FIG. 2 shows an exploded view of the optical element driving mechanism according to some embodiments of the present disclosure.

FIG. 3 shows an exploded perspective view of a first connecting element and a first magnetic element according to some embodiments of the present disclosure.

FIG. 4 shows a top view of a second movable portion, the first connecting element, a second connecting element, and a third connecting element according to some embodiments of the present disclosure.

FIG. 5 shows a perspective view of the optical element driving mechanism according to some embodiments of the present disclosure, wherein a housing is not shown for illustrative purposes.

FIG. 6A shows a perspective view of the bottom according to some embodiments of the present disclosure.

FIG. 6B shows a perspective view of the bottom and the first connecting element according to some embodiments of the present disclosure.

FIG. 7 shows a cross-sectional view of the optical element driving mechanism according to some embodiments of the present disclosure.

### DETAILED DESCRIPTION

Unless otherwise defined, all terms used herein, including technical and scientific terms, shall have the same meaning as commonly understood by one of ordinary skill in the art. It is understood that these terms, such as those defined in commonly used dictionaries, shall be interpreted as having a meaning consistent with the background or context of the relevant art and the present invention, and shall not be interpreted in an idealized or overly formal manner, unless otherwise specifically defined herein.

Furthermore, ordinal terms such as “first,” “second,” and the like, as used in the specification and the claims to modify elements thereof, do not by themselves imply any precedence of the claimed elements, nor do they indicate any order between elements or any sequence in a method of manufacture. Such ordinal terms are used merely to distinguish one element having a certain name from another element having the same name.

In addition, in some embodiments of the present disclosure, terms relating to coupling or connection, such as “connected,” “interconnected,” and the like, unless otherwise defined, may refer to two structures being in direct contact, or may also refer to two structures not being in direct contact, with one or more intermediate structures disposed there between. Such terms relating to coupling or connection may also encompass configurations in which both structures are movable, or in which both structures are fixed.

In the description of the present specification, references to terms such as “one embodiment,” “some embodiments,” “an example,” and the like indicate that the specific features, structures, materials, or characteristics described in connection with the embodiment or example are included in at least one embodiment or example of the present disclosure. In this specification, such terms are not necessarily directed to the same embodiment or example. Furthermore, the specific features, structures, materials, or characteristics described may be combined in any suitable manner in one or more embodiments or examples. In addition, a person having ordinary skill in the art may combine and integrate the different embodiments or examples described in this specification.

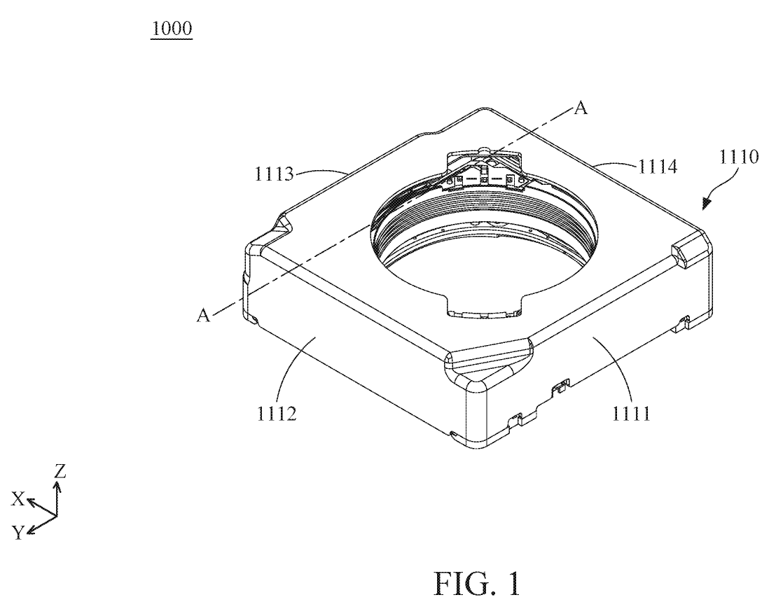

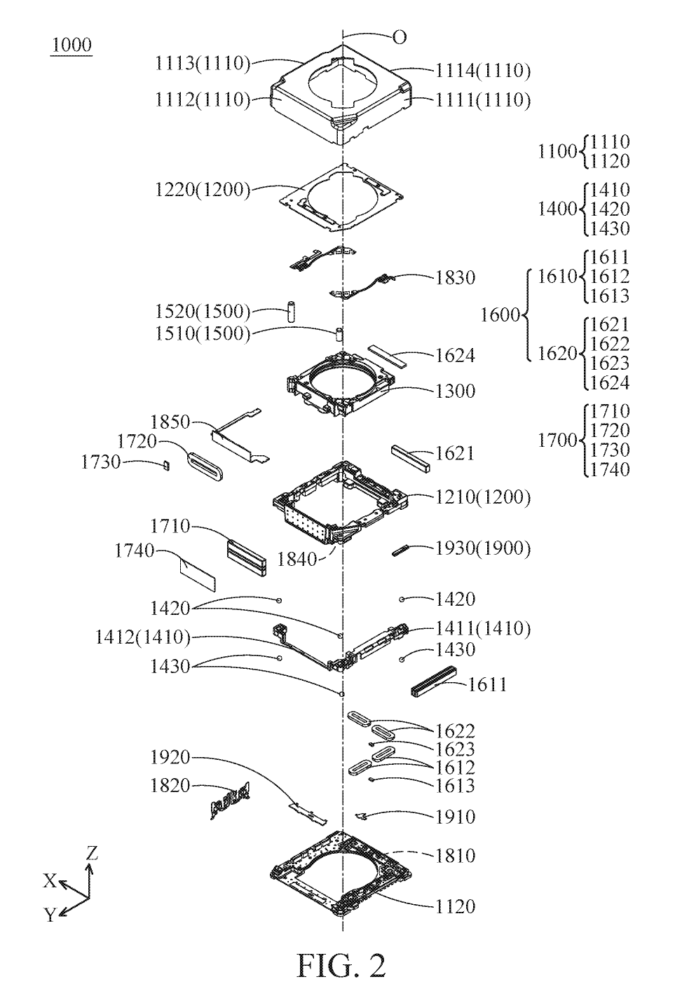

FIG. 1 shows a perspective view of an optical element driving mechanism 1000 according to some embodiments of the present disclosure. FIG. 2 shows an exploded view of the optical element driving mechanism 1000 according to some embodiments of the present disclosure. The overall structure of the optical element driving mechanism 1000 is described in detail below. Please refer to FIGS. 1 and 2.

According to some embodiments of the present disclosure, the optical element driving mechanism 1000 includes a fixed portion 1100, a first movable portion 1200, a second movable portion 1300, a first connecting component 1400, a second connecting component 1500, a first driving component 1600, a second driving component 1700, a first circuit component 1810, a second circuit component 1820, a third circuit component 1830, a fourth circuit component 1840, a fifth circuit component 1850, and a stabilizing component 1900.

According to some embodiments of the present disclosure, the fixed portion 1100 includes a housing 1110 and a bottom 1120. The housing 1110 is fixedly connected to the bottom 1120 to form an accommodating space for accommodating other components of the optical element driving mechanism 1000. As shown in FIGS. 1 and 2, when viewed along an optical axis O, the housing 1110 has a polygonal structure. The optical axis O is parallel to the Z-axis.

According to some embodiments of the present disclosure, the housing 1110 includes a first side 1111, a second side 1112, a third side 1113, and a fourth side 1114. The second side 1112 is not parallel to the first side 1111, the third side 1113 is not parallel to the second side 1112, and the third side 1113 is not parallel to the fourth side 1114. The first side 1111 is parallel to the third side 1113, and the second side 1112 is parallel to the fourth side 1114.

According to some embodiments of the present disclosure, a first movable portion 1200 is configured to connect an optical element (not shown) having an optical axis O. The first movable portion 1200 is movable relative to the fixed portion 1100. The first movable portion 1200 includes a body 1210 and a top cover 1220.

According to some embodiments of the present disclosure, the top cover 1220 of the first movable portion 1200 is fixedly disposed on the body 1210 to form a space for accommodating the second movable portion 1300. The second movable portion 1300 is configured to connect the aforementioned optical element (not shown). The second movable portion 1300 is movable relative to the first movable portion 1200.

It should be understood that, in some embodiments, the first movable portion 1200 is indirectly connected to the aforementioned optical element, while the second movable portion 1300 is directly connected to the aforementioned optical element. However, the present invention is not limited to such a configuration, and different connection arrangements may be adopted according to different requirements.

According to some embodiments of the present disclosure, the first movable portion 1200 is movable relative to the fixed portion 1100 via the first connecting component 1400. The first connecting component 1400 includes a first connecting element 1410, three first intermediate elements 1420, and three second intermediate elements 1430.

According to some embodiments of the present disclosure, the first connecting element 1410 is located between the first movable portion 1200 and the bottom 1120 of the fixed portion 1100. The first connecting element 1410 is movable relative to the fixed portion 1100, and the first movable portion 1200 is movable relative to the first connecting element 1410. A second movable portion 1300 is movable relative to the first connecting element 1410.

According to some embodiments of the present disclosure, the first intermediate element 1420 and the second intermediate element 1430 may be a plurality of balls. The first intermediate element 1420 is located between the first movable portion 1200 and the first connecting element 1410. The second intermediate element 1430 is located between the bottom 1120 of the fixed portion 1100 and the first connecting element 1410.

According to some embodiments of the present disclosure, the second connecting component 1500 may be a pair of guide rods having different lengths. The second movable portion 1300 is movable relative to the fixed portion 1100 via the second connecting component 1500. The second connecting component 1500 includes a second connecting element 1510 and a third connecting element 1520.

According to some embodiments of the present disclosure, the second connecting element 1510 and the third connecting element 1520 have elongated structures and extend along the optical axis O. The maximum dimension of the second connecting element 1510 along the optical axis O is different than the maximum dimension of the third connecting element 1520 along the optical axis O.

According to some embodiments of the present disclosure, when viewed along the optical axis O, the second connecting element 1510 and the third connecting element 1520 are located adjacent to the second side 1112 of the housing 1110, and the second connecting element 1510 is closer to the first side than the third connecting element 1520. The maximum dimension of the second connecting element 1510 along the optical axis O is smaller than the maximum dimension of the third connecting element 1520 along the optical axis O.

According to some embodiments of the present disclosure, the first driving component 1600 is configured to drive the first movable portion 1200 to move relative to the fixed portion 1100. The first driving component 1600 includes a first driving portion 1610 and a second driving portion 1620. The first driving portion 1610 drives the first connecting element 1410 to move in the X-axis direction, thereby causing the first connecting element 1410 to move the first movable portion 1200 and the second movable portion 1300 in the X-axis direction. The second driving portion 1620 drives the first movable portion 1200 to move in the Y-axis direction, thereby causing the first movable portion 1200 to move the second movable portion 1300 in the Y-axis direction.

According to some embodiments of the present disclosure, the first driving portion 1610 includes a first magnetic element 1611, two first coils 1612, and a sensing element 1613. The first magnetic element 1611 is disposed on the first connecting element 1410. The first coils 1612 are disposed on the bottom 1120 of the fixed portion 1100.

According to some embodiments of the present disclosure, the first magnetic element 1611 corresponds to the first coil 1612. More specifically, when a driving signal (e.g., a current supplied by an external power source) is applied to the first coil 1612, an electromagnetic force is generated between the first magnetic element 1611 and the first coil 1612, thereby driving the first connecting element 1410 to move along the X-axis, so as to drive the optical element to a desired position.

According to some embodiments of the present disclosure, the sensing element 1613 is disposed on the bottom 1120. The sensing element 1613 is configured to detect a magnetic field variation generated by the first magnetic element 1611 and convert the magnetic field variation into a corresponding electrical signal, so as to achieve closed-loop control of the optical element driving mechanism 1000.

According to some embodiments of the present disclosure, the second driving portion 1620 includes a second magnetic element 1621, two second coils 1622, a sensing element 1623, and a magnetically permeable element 1624. The second magnetic element 1621 is disposed on the first movable portion 1200. The second coils 1622 are disposed on the bottom 1120 of the fixed portion 1100.

According to some embodiments of the present disclosure, the second magnetic element 1621 corresponds to the second coil 1622. When a driving signal (e.g., a current supplied by an external power source) is applied to the second coil 1622, an electromagnetic force is generated between the second magnetic element 1621 and the second coil 1622, thereby driving the first movable portion 1200 to move along the Y-axis, so as to drive the optical element to a desired position.

According to some embodiments of the present disclosure, the sensing element 1623 is disposed on the bottom 1120. The sensing element 1623 is configured to detect a magnetic field variation generated by the second magnetic element 1621 and convert the magnetic field variation into a corresponding electrical signal, so as to achieve closed-loop control of the optical element driving mechanism 1000.

According to some embodiments of the present disclosure, the magnetically permeable element 1624 is disposed on the first movable portion 1200. The magnetically permeable element 1624 has a high magnetic permeability (e.g., iron, silicon steel, or the like) and is configured to effectively guide a path of magnetic flux, so as to concentrate the magnetic flux within a magnetic circuit formed by the coil and the magnet, thereby enhancing magnetic field strength and increasing magnetic force.

According to some embodiments of the present disclosure, the second driving component 1700 is configured to drive the second movable portion 1300 to move relative to the fixed portion 1100. The second driving component 1700 includes a third magnetic element 1710, a third coil 1720, a sensing element 1730, and a magnetically permeable element 1740. The third magnetic element 1710 is disposed on the first movable portion 1200. The third coil 1720 is disposed on the second movable portion 1300.

According to some embodiments of the present disclosure, the third magnetic element 1710 corresponds to the third coil 1720. More specifically, when a driving signal (e.g., a current supplied by an external power source) is applied to the third coil 1720, an electromagnetic force is generated between the third magnetic element 1710 and the third coil 1720, thereby driving the second movable portion 1300 to move along the optical axis O, so as to drive the optical element to a desired position.

According to some embodiments of the present disclosure, the sensing element 1730 is disposed on the second movable portion 1300. The sensing element 1730 is configured to detect a magnetic field variation generated by the third magnetic element 1710 and convert the magnetic field variation into a corresponding electrical signal, so as to achieve closed-loop control of the optical element driving mechanism 1000.

According to some embodiments of the present disclosure, the magnetically permeable element 1740 is disposed on the first movable portion 1200. The magnetically permeable element 1740 has a high magnetic permeability (e.g., iron, silicon steel, or the like) and is configured to effectively guide a path of magnetic flux, so as to concentrate the magnetic flux within a magnetic circuit formed by the coil and the magnet, thereby enhancing magnetic field strength and increasing magnetic force.

According to some embodiments of the present disclosure, the first circuit component 1810 is disposed on the bottom 1120 of the fixed portion 1100 and configured to connect an external circuit. More specifically, the first circuit component 1810 is metal terminals at least partially embedded within the bottom 1120. The first coil 1612, the second coil 1622, and the sensing elements 1613 and 1623 disposed on the bottom 1120 are all electrically connected to the first circuit component 1810.

According to some embodiments of the present disclosure, the second circuit component 1820 may be an upright spring member having a plate-like structure. The second circuit component 1820 is configured to be electrically connected to an external circuit. The second circuit component 1820 is not perpendicular to the optical axis O. The second circuit component 1820 has a thickness greater than 0.02 mm. When viewed along the optical axis O, the second circuit component 1820 is located at the third side 1113 of the fixed portion 1100 having a polygonal structure.

According to some embodiments of the present disclosure, the third circuit component 1830 is electrically connected to the second circuit component 1820. The third circuit component 1830 has a plate-like structure. The third circuit component 1830 is not parallel to the second circuit component 1820. The third circuit component 1830 is not parallel to the optical axis O.

According to some embodiments of the present disclosure, the fourth circuit component 1840 is disposed in the first movable portion 1200, and the fourth circuit component 1840 is at least partially embedded and not exposed in the first movable portion 1200. In other words, the fourth circuit component 1840 is metal terminals at least partially embedded within the body 1210 of the first movable portion 1200. The fourth circuit component 1840 is electrically connected to the third circuit component 1830.

According to some embodiments of the present disclosure, the fifth circuit component 1850 may be a flexible printed circuit board. The fifth circuit component 1850 is disposed on the second movable portion 1300. The third coil 1720 and the third sensing element 1730 are electrically connected to the fifth circuit component 1850.

According to some embodiments of the present disclosure, the stabilizing component 1900 is configured to generate a stabilizing force to urge the first movable portion 1200 toward the bottom 1120 of the fixed portion 1100. The stabilizing component 1900 includes a first stabilizing element, a second stabilizing element 1910, a third stabilizing element, a fourth stabilizing element 1920, and a fifth stabilizing element 1930.

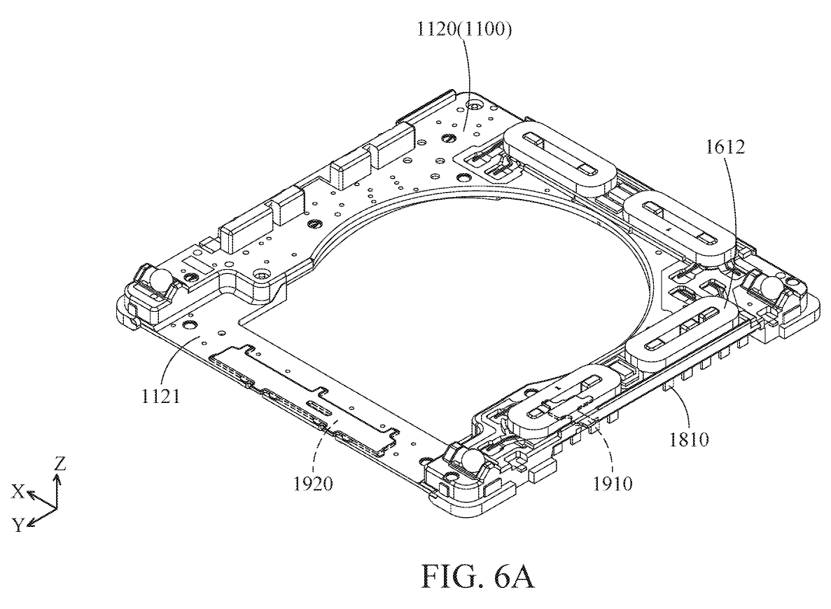

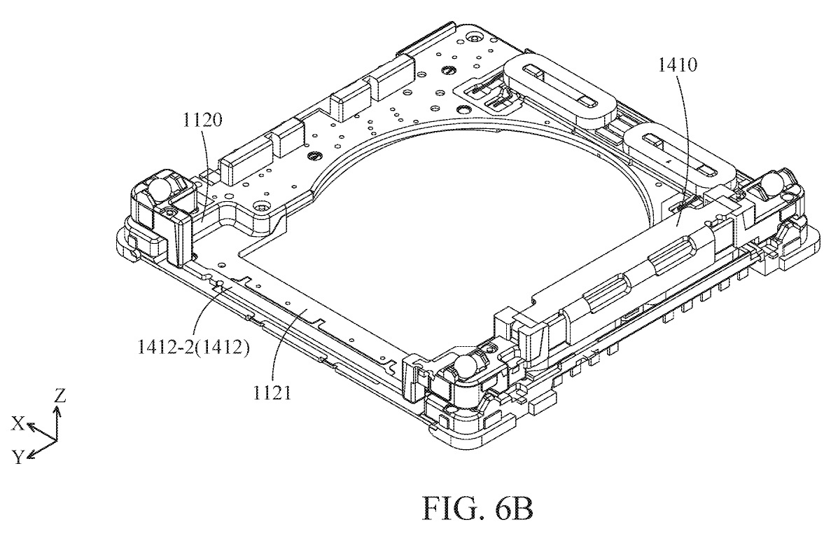

FIG. 2 shows the second stabilizing element 1910, the fourth stabilizing element 1920, and the fifth stabilizing element 1930 of the stabilizing component 1900. The arrangement of the first stabilizing element and third stabilizing element is described in detail with reference to FIGS. 6A and 6B.

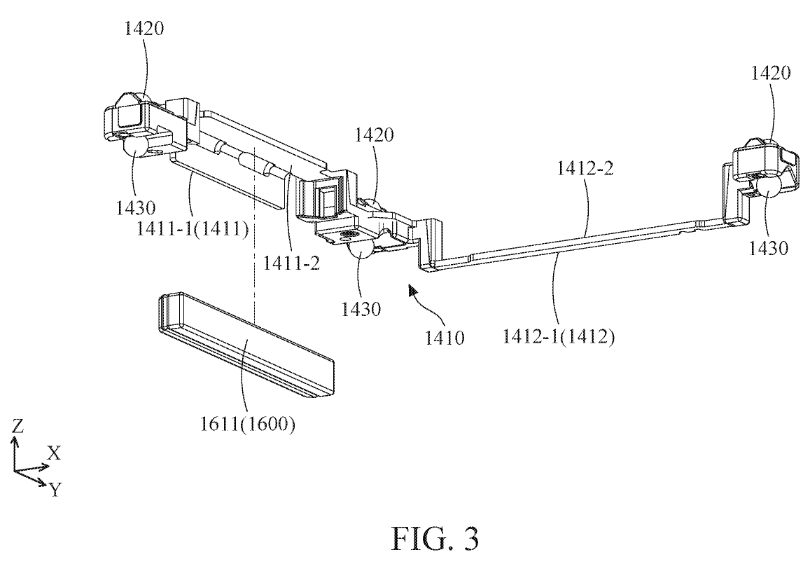

FIG. 3 shows an exploded perspective view of the first connecting element 1410 and the first magnetic element 1611 according to some embodiments of the present disclosure. As shown in FIG. 3, the first connecting element 1410 includes a first base 1411 and a second base 1412.

According to some embodiments of the present disclosure, the first base 1411 has a first recessed structure 1411-1. The first recessed structure 1411-1 corresponds to the first magnetic element 1611 of the first driving component 1600. The second base 1412 has a second recessed structure 1412-1. The second recessed structure 1412-1 corresponds to at least a portion of the first movable portion 1200 (FIG. 2).

According to some embodiments of the present disclosure, a first base surface 1411-2 of the first recessed structure 1411-1 faces the first magnetic element 1611 of the first driving component 1600, and a second base surface 1412-2 of the second recessed structure 1412-1 faces the first movable portion 1200 (FIG. 2). The first base surface 1411-2 and the second base surface 1412-2 face opposite directions. The first base surface 1411-2 and the second base surface 1412-2 are perpendicular to the optical axis O.

According to some embodiments of the present disclosure, along the optical axis O, the first intermediate element 1420 is closer to the first base surface 1411-2 than to the second base surface 1412-2. Along the optical axis O, the second intermediate element 1430 is closer to the second base surface 1412-2 than to the first base surface 1411-2.

As shown in FIG. 3, when viewed along a direction parallel to the first viewing direction (which is parallel to the Y-axis), the first base surface 1411-2 does not overlap the second base 1412. When viewed along the direction parallel to the first viewing direction (which is parallel to the Y-axis), the second base surface 1412-2 does not overlap the first base 1411.

Referring temporarily to FIGS. 2 and 3, when viewed along the optical axis O, the first base 1411 is located adjacent to the first side 1111 of the housing 1110. When viewed along the optical axis O, the second base 1412 is located adjacent to the second side 1112 of the housing 1110.

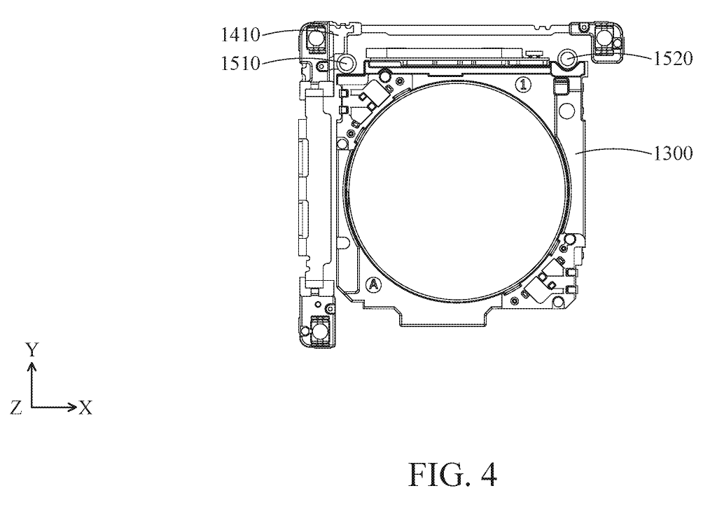

FIG. 4 shows a top view of the second movable portion 1300, the first connecting element 1410, the second connecting element 1510, and the third connecting element 1520 according to some embodiments of the present disclosure. As shown in FIG. 4, when viewed along the optical axis O, the second connecting element 1510 at least partially overlaps the first connecting element 1410. When viewed along the optical axis O, the third connecting element 1520 does not overlap the first connecting element 1410.

Accordingly, by providing the second connecting element 1510 and the third connecting element 1520 with different lengths, and disposing the shorter connecting element above the first connecting element 1410 to avoid interference with the first connecting element 1410, interference can be prevented while ensuring proper operation of the guiding structure, thereby achieving a more compact overall structural configuration and improving stability during movement.

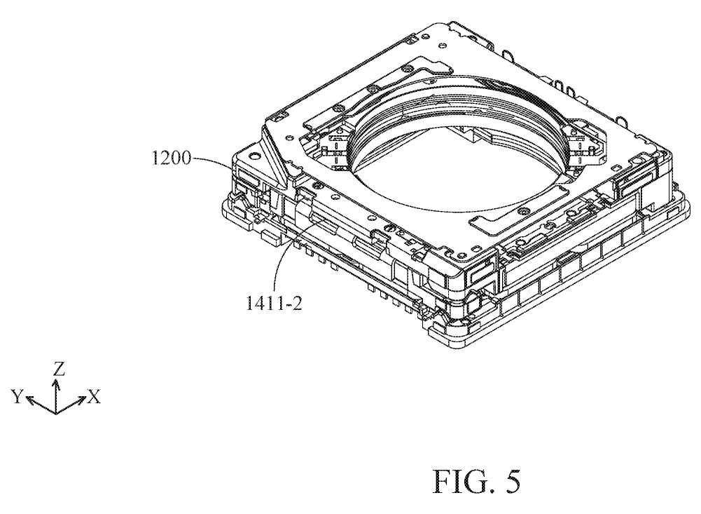

FIG. 5 shows a perspective view of the optical element driving mechanism 1000 according to some embodiments of the present disclosure, wherein the housing 1110 is not shown for illustrative purposes. As shown in FIG. 5, when viewed along the first viewing direction (parallel to the Y-axis) parallel to the first base surface 1411-2, the first base surface 1411-2 at least partially overlaps the first movable portion 1200.

FIG. 6A shows a perspective view of the bottom 1120 according to some embodiments of the present disclosure. FIG. 6B shows a perspective view of the bottom 1120 and the first connecting element 1410 according to some embodiments of the present disclosure. As shown in FIG. 6A, the bottom 1120 has a third recessed structure 1121 that is recessed relative to the location where the first coil 1612 is disposed.

As shown in FIG. 6B, the third recessed structure 1121 of the bottom 1120 corresponds to the second base 1412 of the first connecting element 1410. When viewed along a first viewing direction (parallel to the Y-axis), the second base surface 1412-2 at least partially overlaps the bottom 1120. When viewed along the first viewing direction (parallel to the Y-axis), the second base surface 1412-2 at least partially overlaps the first circuit component 1810, which is at least partially embedded in the bottom 1120.

As shown in FIG. 6A, the second stabilizing element 1910 and the fourth stabilizing element 1920 of the stabilizing component 1900, which are partially embedded in the bottom 1120, can be seen. Referring temporarily to FIG. 2, the first magnetic element 1611 of the first driving component 1600 may serve as the first stabilizing element of the stabilizing component, and the first stabilizing element is fixedly disposed on the first connecting element 1410. The third magnetic element 1710 of the second driving component 1700 may serve as the third stabilizing element of the stabilizing component, and the third stabilizing element is fixedly disposed on the first movable portion 1200.

Referring to FIGS. 2 and 6A, the second stabilizing element 1910 is fixedly disposed on the bottom 1120 of the fixed portion 1100. The second stabilizing element 1910 and the first stabilizing element (i.e., the first magnetic element 1611 of the first driving component 1600 in FIG. 2) generate a first stabilizing force.

Referring to FIGS. 2 and 6A, the fourth stabilizing element 1920 is fixedly disposed on the bottom 1120 of the fixed portion 1100. The fourth stabilizing element 1920 and the third stabilizing element (i.e., the third magnetic element 1710 of the second driving component 1700 in FIG. 2) generate a second stabilizing force.

Referring temporarily to FIG. 2, when viewed along the optical axis O, the first stabilizing element (i.e., the first magnetic element 1611 in FIG. 2) is located on the first side 1111 of the fixed portion 1100. When viewed along the optical axis O, the third stabilizing element (i.e., the third magnetic element 1710 in FIG. 2) is located on the second side 1112 of the fixed portion 1100. In this embodiment, both the first and third stabilizing elements are magnets.

As shown in FIG. 2, the fifth stabilizing element 1930 is fixedly disposed in the first movable portion 1200. The fifth stabilizing element 1930 is configured to generate a third stabilizing force. When viewed along the optical axis O, the fifth stabilizing element 1930 is located on the first side 1111 of the fixed portion 1100. The fifth stabilizing element 1930 and the first stabilizing element (i.e., the first magnetic element 1611) generate the third stabilizing force.

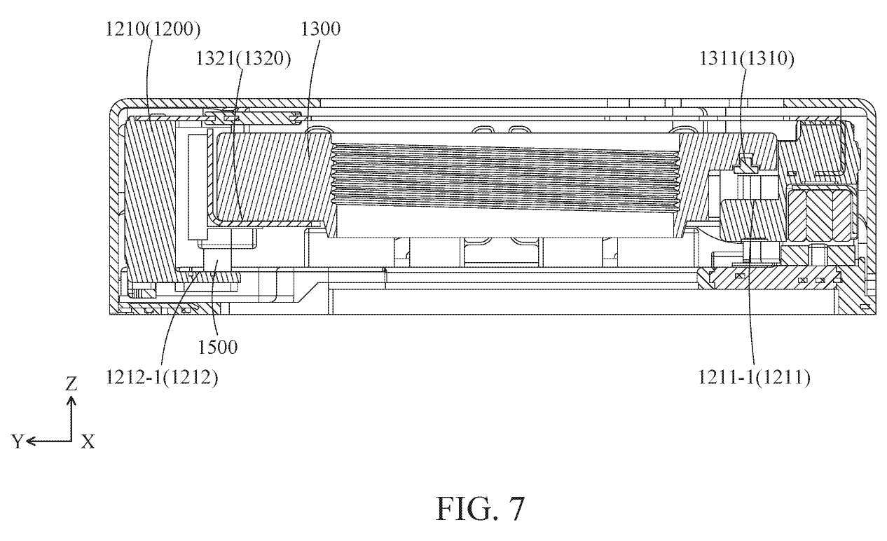

FIG. 7 shows a cross-sectional view of the optical element driving mechanism 1000 according to some embodiments of the present disclosure. The optical element driving mechanism 1000 further includes a stop component for limiting the range of motion of the second movable portion 1300. The stop component includes a first stop element, a second stop element, a third stop element, and a fourth stop element.

More specifically, as shown in FIG. 7, the second movable portion 1300 includes a first stop element 1310 (i.e., the first stop element of the stop component in this embodiment) and a second stop element 1320 (i.e., the second stop element of the stop component in this embodiment). The body 1210 of the first movable portion 1200 includes a third stop element 1211 (i.e., the third stop element of the stop component in this embodiment) and a fourth stop element 1212 (i.e., the fourth stop element of the stop component in this embodiment).

According to some embodiments of the present disclosure, the first stop element 1310 has a first stop surface 1311. The second stop element 1320 has a second stop surface 1321. The first stop surface 1311 and the second stop surface 1321 face the same direction, and the first stop surface 1311 and the second stop surface 1321 are perpendicular to the optical axis O.

According to some embodiments of the present disclosure, along the optical axis O, a gap is present between the first stop surface 1311 and the second stop surface 1321. In other words, the first stop surface 1311 and the second stop surface 1321 are located at different heights along the optical axis O.

According to some embodiments of the present disclosure, the third stop element 1211 has a third stop surface 1211-1, and the third stop surface 1211-1 faces the first stop surface 1311. The fourth stop element 1212 has a fourth stop surface 1212-1, and the fourth stop surface 1212-1 faces the second stop surface 1321.

According to some embodiments of the present disclosure, when viewed along the optical axis O, the first stop surface 1311 and the third stop surface 1211-1 at least partially overlap. When viewed along the optical axis O, the second stop surface 1321 and the fourth stop surface 1212-1 at least partially overlap. The shortest distance between the first stop surface 1311 and the third stop surface 1211-1 is different from the shortest distance between the second stop surface 1321 and the fourth stop surface 1212-1.

According to some embodiments of the present disclosure, when viewed along the optical axis O, the shortest distance between the first stop element 1310 and the second connecting component 1500 is different from the shortest distance between the second stop element 1320 and the second connecting component 1500. The first stop surface 1311 and the second stop surface 1321 are on the second movable portion 1300, and the third stop surface 1211-1 and the fourth stop surface 1212-1 are on the first movable portion 1200.

According to some embodiments of the present disclosure, the shortest distance between the first stop surface 1311 and the third stop surface 1211-1 is smaller than the shortest distance between the second stop surface 1321 and the fourth stop surface 1212-1. When viewed along the optical axis O, the second stop element 1320 is closer to the second connecting component 1500 than the first stop element 1310.

In summary, the present disclosure provides a configuration in which driving structures are respectively disposed on different movable portions, such that each movable portion may be driven in its corresponding direction of motion. Under certain operating conditions, the weight of components required to be driven may be reduced, thereby helping to reduce moving load and improve driving efficiency. In addition, by using a guiding structure to constrain the direction of movement of the movable portions, unintended rotation or deviation that may occur during movement can be suppressed, thereby further improving overall motion stability and reliability.

Although embodiments of the present invention and advantages thereof have been described above, it should be understood that any person having ordinary skill in the art may make modifications, substitutions, and alterations without departing from the spirit and scope of the present invention. In addition, the scope of protection of the present invention is not limited to the specific processes, machines, manufactures, compositions of matter, apparatuses, methods, and steps described in the specification. Any processes, machines, manufactures, compositions of matter, apparatuses, methods, or steps, whether currently existing or later developed, that perform substantially the same function or achieve substantially the same result as the corresponding embodiments described herein may be utilized according to the present invention. Accordingly, the scope of the present invention is intended to include such processes, machines, manufactures, compositions of matter, apparatuses, methods, and steps. Furthermore, each claim constitutes a separate embodiment, and the scope of the present invention also encompasses combinations of the claims and the embodiments.

What is claimed is:

1. An optical element driving mechanism, comprising:
a first movable portion, configured to connect an optical element having an optical axis;
a fixed portion, wherein the first movable portion is movable relative to the fixed portion; and
a first driving component, configured to drive the first movable portion to move relative to the fixed portion.

2. The optical element driving mechanism as claimed in claim 1, further comprising a first connecting component, wherein the first movable portion is movable relative to the fixed portion via the first connecting component.

3. The optical element driving mechanism as claimed in claim 2, wherein the first connecting component comprises a first connecting element, the first connecting element is located between the first movable portion and the fixed portion, the first connecting element is movable relative to the fixed portion, and the first movable portion is movable relative to the first connecting element.

4. The optical element driving mechanism as claimed in claim 3, wherein the first connecting element comprises:
a first base having a first recessed structure and corresponding to at least a portion of the first driving component; and
a second base having a second recessed structure and corresponding to at least a portion of the first movable portion.

5. The optical element driving mechanism as claimed in claim 4, wherein a first base surface of the first recessed structure faces the first driving component, and a second base surface of the second recessed structure faces the first movable portion; and the first base surface and the second base surface face opposite directions.

6. The optical element driving mechanism as claimed in claim 5, wherein the first base surface and the second base surface are perpendicular to the optical axis; wherein when viewed along a first viewing direction parallel to the first base surface, the first base surface at least partially overlaps the first movable portion.

7. The optical element driving mechanism as claimed in claim 6, wherein the fixed portion has a polygonal structure when viewed along the optical axis, and the fixed portion further comprises:
a first side; and
a second side, not parallel to the first side;
wherein when viewed along the optical axis, the first base is located on the first side;
wherein when viewed along the optical axis, the second base is located on the second side.

8. The optical element driving mechanism as claimed in claim 7, wherein the fixed portion further comprises a bottom, and a third recessed structure of the bottom corresponds to the second base;
wherein when viewed along the first viewing direction, the second base surface at least partially overlaps the bottom.

9. The optical element driving mechanism as claimed in claim 8, further comprising a first circuit component disposed on the bottom and configured to connect to an external circuit;
wherein when viewed along the first viewing direction, the second base surface at least partially overlaps the first circuit component.

10. The optical element driving mechanism as claimed in claim 9, wherein when viewed along a direction parallel to the first viewing direction, the first base surface does not overlap the second base surface;
when viewed along the direction parallel to the first viewing direction, the second base surface does not overlap the first base surface.

11. The optical element driving mechanism as claimed in claim 10, wherein the first connecting component further comprises:
a first intermediate element, located between the first movable portion and the first connecting element; and
a second intermediate element, located between the fixed portion and the first connecting element;
wherein the first intermediate element is closer to the first base surface than to the second base surface along the optical axis;
wherein the second intermediate element is closer to the second base surface than to the first base surface along the optical axis.

12. The optical element driving mechanism as claimed in claim 10, further comprising:
a second movable portion for connecting the optical element; and
a second connecting component, wherein the second movable portion is movable relative to the fixed portion via the second connecting component;
wherein the second movable portion is movable relative to the first movable portion, and the second movable portion is movable relative to the first connecting element.

13. The optical element driving mechanism as claimed in claim 12, wherein the second connecting component comprises a second connecting element and a third connecting element, the second connecting element and the third connecting element each have an elongated structure and extend along the optical axis;
wherein on the optical axis, a maximum size of the second connecting element is different from a maximum size of the third connecting element;
wherein when viewed along the optical axis, the second connecting element and the third connecting element are located on the second side, and the second connecting element is closer to the first side than the third connecting element.

14. The optical element driving mechanism as claimed in claim 13, wherein on the optical axis, the maximum size of the second connecting element is smaller than the maximum size of the third connecting element;
wherein along the optical axis, the second connecting element at least partially overlaps the first connecting element;
wherein when viewed along the optical axis, the third connecting element does not overlap the first connecting element.

15. The optical element driving mechanism as claimed in claim 12, further comprising a stop component for limiting the range of motion of the second movable portion, the stop component comprising:
a first stop element having a first stop surface; and
a second stop element having a second stop surface;
wherein the first stop surface and the second stop surface face the same direction, and the first stop surface and the second stop surface are perpendicular to the optical axis;
wherein there is a gap between the first stop surface and the second stop surface on the optical axis.

16. The optical element driving mechanism as claimed in claim 15, wherein the stop component further comprises:
a third stop element having a third stop surface facing the first stop surface; and
a fourth stop element having a fourth stop surface facing the second stop surface;
wherein when viewed along the optical axis, the first stop surface and the third stop surface at least partially overlap;
wherein when viewed along the optical axis, the second stop surface and the fourth stop surface at least partially overlap.

17. The optical element driving mechanism as claimed in claim 16, wherein a shortest distance between the first stop surface and the third stop surface is different from a shortest distance between the second stop surface and the fourth stop surface;
wherein when viewed along the optical axis, a shortest distance between the first stop element and the second connecting component is different from a shortest distance between the second stop element and the second connecting component.

18. The optical element driving mechanism as claimed in claim 16, wherein the first stop surface and the second stop surface are located on the second movable portion, and the third stop surface and the fourth stop surface are located on the first movable portion.

19. The optical element driving mechanism as claimed in claim 16, wherein the shortest distance between the first stop surface and the third stop surface is smaller than the shortest distance between the second stop surface and the fourth stop surface.

20. The optical element driving mechanism as claimed in claim 16, wherein when viewed along the optical axis, the second stop element is closer to the second connecting component than the first stop element.
